(19) United States
(12) Patent Application Publication
(10) Pub. No.: US 2010/0077767 A1
(43) Pub. Date: Apr. 1, 2010

(54) EMISSION FREE INTEGRATED GASIFICATION COMBINED CYCLE

(76) Inventors: Maria Balmas, Hacienda Heights, CA (US); Henry C. Chan, Fountain Valley, CA (US); Craig Skinner, Newport Beach, CA (US)

Correspondence Address: CAROL WILSON;BP AMERICA INC., MAIL CODE 5 EAST, 4101 WINFIELD ROAD, WARRENVILLE, IL, 60555, US

(21) Appl. No.: 12/594,221

(22) PCT Filed: Apr. 9, 2008
(86) PCT No.: PCT/US08/59751

§ 371 Date: Oct. 1, 2009

Related U.S. Application Data
(60) Provisional application No. 60/911,022, filed on Apr. 10, 2007.

(51) Int. Cl. F02C 3/28; C10L 3/08; F01K 23/06

(52) U.S. Cl. 60/780; 48/197 FM

(57) ABSTRACT

Disclosed is a process to start-up, operate, and shut down a gasifier and an integrated gasification combined cycle complex without flaring while additionally reducing the release of contaminants such as carbon monoxide, hydrogen sulfide, and nitrogen oxides. The process is accomplished by scrubbing ventable sour gases and passing scrubbed sour gases and ventable sweet gases to a vent gas combustor for controlled combustion prior to release of any such gases to the atmosphere. Additionally, the gases are subjected to a CO oxidation treatment and selective catalytic reduction treatment prior to release to the atmosphere.

### BACKGROUND OF THE INVENTION

The present invention relates to systems and methods of starting up, operating and shutting down a gasification reactor and an integrated gasification combined cycle (“IGCC”) complex.

Gasification was first used to produce “town gas” for light and heat. Additionally, coal and other hydrocarbons have been gasified in the past to produce various chemicals and synthetic fuels. More recently gasification technology has been employed to generate electricity in an IGCC complex wherein coal or another hydrocarbon is gasified by partial oxidation using oxygen or air to syngas. Typically, this syngas is then cleaned of particulates, sulfur compounds and nitrogen compounds such as NOₓ compounds and then subsequently passed to gas turbine where it is fired. Additionally the hot exhaust gas from the gas turbine is usually passed to a heat recovery steam generator where steam is produced to drive a steam turbine. Electrical power is then produced from the gas turbine and the steam turbine. These IGCC complexes can also be designed to produce hydrogen and capture CO₂ thereby reducing greenhouse gas emissions. Because the emission-forming components are removed from the syngas prior to combustion an IGCC complex produces very low levels of air contaminants, such as NOₓ, SO₂, particulate matter and volatile mercury.

As mentioned above any hydrocarbon can be gasified, i.e. partially combusted, in contradistinction to combustion, by using less than the stoichiometric amount of oxygen required to combust the solid. Generally the oxygen supply is limited to about 20 to 70 percent of the oxygen required for complete combustion. The reaction of the hydrocarbon-containing feedstock with limited amounts of oxygen results in the formation of hydrogen, carbon monoxide and some water and carbon dioxide. Solids such as coal, biomass, oil refinery bottoms, digester sludge and other carbon-containing materials can be used as feedstocks to gasifiers. Recently petroleum coke has been used as the solid hydrocarbon feed stock for IGCC.

A typical gasifier operates at very high temperatures such as temperatures ranging from about 1000° C. to about 1400° C. and in excess of 1,600° C. At such high temperatures any inert material in the feedstock is melted and flows to the bottom of the gasification vessel where it forms an inert slag. There are three basic types of gasifiers that are either air or oxygen fed gasifiers. Specifically, gasifiers can be characterized as a moving bed, an entrained flow, or a fluidized bed. Moving bed gasifiers generally contact the fuel in countercurrent fashion. Briefly, the carbon-containing fuel is fed into the top of a reactor where it contacts oxygen, steam and/or air in counter-current fashion until it has reacted to form syngas. In the entrained flow gasifier the fuel or hydrocarbon-containing feedstock contacts the oxidizing gas in co-current fashion until syngas is produced which exists the top of the reactor while slag flows to the bottom of the reactor. Finally, in the fluidized-bed gasifier the hydrocarbon-containing fuel or feedstock is passed upwards with a steam/oxygen gas where it is suspended until the gasification reaction takes place.

The gasifier in an IGCC complex is integrated with an air separation unit (“ASU”), a gas purification or clean up system such as an acid gas removal (“AGR”) process, and a combined cycle power plant or “power block” which is the gas turbine unit. The ASU is used to separate air such that a pure oxygen stream can be sent to the gasifier.

In order to convert syngas produced by the gasifier to hydrogen fuel for both power generation and/or hydrogen sales, the syngas from the gasification block or gasifier must be shifted to convert the CO and water in the syngas to CO₂ and hydrogen. The water gas shift reaction is:

CO+H₂O→CO₂+H₂

CO shift technology is commonly used in conventional hydrogen and ammonia plants. Where the syngas is derived from gasification, the CO shift unit is typically located upstream of a sulfur removal unit and therefore uses “sour” shift catalysts. Shift catalysts can be cobalt-molybdenum-based catalysts which are readily commercially available from a number of suppliers. The catalyst life is typically three years. For a high degree of CO₂ capture additional stages of shift may be required. The heat from the highly exothermic shift reaction can be effectively utilized by generating steam for internal plant consumption.

As set out above this “shift reaction” is practiced widely in the refining and petrochemical industries. Examples of gasification plants utilizing sour shift technology include the Convent Hydrogen Plant in Louisiana, the Dakota Gasification Plant in North Dakota, and the petcoke gasification plant in Coffeyville, Kans. The Coffeyville plant uses gasification technology for ammonia and CO₂ production.

Where an IGCC complex is used to capture CO₂ the CO₂ captured must meet purity standards for compression and injection if the CO₂ is to be injected into oil fields for enhanced oil recovery. An extremely high degree of carbon capture can be achieved by shifting almost all the CO in the raw sour synthesis gas to carbon dioxide and hydrogen, and then recovering nearly all of the CO₂ in the resultant syngas within a downstream AGR unit.

In an IGCC complex as contemplated herein, shifted syngas effluent from the shift reactor is passed to an acid gas removal unit. A suitable acid gas removal unit could be the Rectisol process licensed by Lurgi AG or Linde AG. The Rectisol Process uses a physical solvent, unlike amine based acid removal solvents that rely on a chemical reaction with the acid gases. While any acid gas removal process can be utilized the Rectisol Process is preferably utilized due to (1) the high syngas pressure and (2) the proven ability of the process to (i) achieve very low (<2 ppmv) sulfur levels in treated fuel gas effluents, (ii) simultaneously produce an acid gas that is suitable for a Claus sulfur recovery unit (“SRU”) and (iii) a CO₂ stream that is suitable for enhanced oil recovery (“EOR”) applications. The deep sulfur removal achieved in the Rectisol unit allows a downstream power block to achieve NOₓ, CO and SO₂ emission levels that are comparable to those for a natural gas-fired combined cycle power plants, but with much lower CO₂ emissions. Ultra-low sulfur content in gas turbine (“GT”) fuel is necessary to allow use of catalysts for CO and NOₓ reduction in the GT exhaust because sulfur compounds react with ammonia used in the selective catalytic reduction process to form sticky particulates that adhere to catalyst and heat recovery steam generator (“HRSG”) tube surfaces. Another advantage of Rectisol is that it can remove nearly all COS from the syngas, thus eliminating the need for an upstream hydrolysis reactor that would otherwise be needed to convert COS in the syngas to H₂S.

As mentioned above the Rectisol is a purely physical absorption process, which is carried out at low temperatures and benefits from high operating pressure. The absorption medium is methanol. Mass transfer from the gas into the methanol solvent is driven by the concentration gradient of the respective component between the gas and the surface of the solvent, the latter being dictated by the absorption equilibrium of the solvent with regard to this component. The compounds absorbed are removed from the solvent by flashing (desorption) and additional thermal regeneration, so that the solvent is ready for new absorption. The relative ease of removing CO₂ from high pressure synthesis gas as compared to removing it from atmospheric pressure, nitrogen-diluted flue gas is widely recognized as one of the principal benefits of gasification when compared to combustion technologies.

CO₂ produced by such an IGCC complex is 99%+ pure with only small traces of other compounds present. This level of purity is required for several reasons. First, it is essential for the product to be very low in water content to minimize or alleviate the formation of carbonic acid (water+CO₂=carbonic acid) which is very corrosive to the steel used in the compression equipment, pipeline, injection/re-injection equipment and the actual wells themselves. Second, the total sulfur content is limited to 30 ppmv or less to further minimize corrosion issues and to mitigate any health concerns to workers or the public in the event of a mechanical failure or release. Third, nitrogen in the product is limited to less than about 2 vol % since excessive amounts of nitrogen may significantly inhibit EOR and permanent sequestration of CO₂.

The Rectisol unit can be used to produce high purity CO₂ at two pressure levels, atmospheric pressure and about three atmospheres. EOR operations require a CO₂ pressure of 2,000 psig (13.79 MPa), so CO₂ compression above this level is required. CO₂ enters a dense, supercritical phase at about 1,100 psig (7.58 MPa), therefore it remains in a single phase throughout a CO₂ pipeline. The Rectisol acid gas removal unit also produces an acid gas stream containing H₂S.

The sulfur recovery unit (“SRU”) used in the IGCC complex contemplated herein can be a conventional oxygen-blown Claus technology to convert the H₂S to liquid elemental sulfur. The tail gas from the Claus unit can be recycled to the AGR unit to avoid any venting of sulfurous compounds to the atmosphere.

While the hydrogen produced in the present IGCC complex is generally used for power production, during off peak demand a portion of such hydrogen can be directed to petroleum refineries after suitable purification using, for instance, conventionally available pressure swing adsorption technology.

The combustion of the hydrogen fuel to produce power can be carried out by any conventional gas turbines. These turbines can each exhaust into a heat recovery and steam generator (“HRSG”). Steam can be generated at three pressure levels and is used to generate additional electrical energy in a steam turbine.

A conventional selective catalytic reduction process (“SCR”) can be used for post-combustion treatment of effluent gases to reduce NOₓ content down to acceptable levels.

In a conventional start-up of a partial oxidation gas generating process the gas generator is started at atmospheric pressure after preheating to at least 950° C. Until the gasifier is pressurized and downstream processes are brought on-stream the resulting effluent, comprising syngas, is typically burned in a flare. As is well known to those skilled in the art, this results in higher than normal emissions of contaminants such as sulfur. See, for example, U.S. Pat. No. 4,385,906 (Estabrook) and U.S. Pat. No. 3,816,332 (Marion).

Accordingly, the start-up of a partial oxidation gas generator presents special challenges, including dealing with the contaminant emissions. For example, U.S. Pat. No. 4,378,974 (Petit et al.) discloses a start-up method for a coal gasification plant, in particular a refractory lined rotary kiln. The method of Petit et al. focuses on the problems that arise from coal having a high chlorine content. Petit et al. discloses a reactor where the lining is made of materials susceptible to chlorine-induced cracking in the presence of oxygen. Petit et al. teaches starting the reactor up in stages while maintaining an oxygen content in the reactor at a sufficiently low level to prevent chlorine-induced cracking of the refractory lining.

Additionally, U.S. Pat. No. 4,385,906 (Estabrook) discloses a start-up method for a gasification system comprising a gas generator and a gas purification train. In the method disclosed by Estabrook the gas purification train is isolated and prepressurized to 50% of its normal operating pressure. The gas generator is then started, and its pressure increased before establishing communication between the generator and the purifier. Purified gases from the purifier may then be burned in a flare until all parts of the process reach appropriate temperature and pressure.

U.S. Pat. No. 6,033,447 (Moock et al.) discloses a start-up method for a gasification system with a sulfur-free organic liquid, such as propanol. The reference claims that air contaminants, such as sulfur, which are characteristic of start-up, may be eliminated by starting the gasifier with a sulfur-free, liquid organic fuel. Once the gasifier is started up using a sulfur-free liquid organic fuel and reaches the appropriate temperature and pressure conditions the burner is transitioned to a carbonaceous fossil fuel slurry. Only sulfur-free gas is flared.

The present invention deals with the start-up of a gasifier or an IGCC complex without flaring. Flaring is an uncontrolled combustion of flammable gas at the flare tip. Flare flames are visible from substantial distances. The combustion is carried outside the flare tip at the adiabatic flame temperature of the flammable gas, typically as high as 3,000° F. (1649° C.). The radiation and the heat affected zone of a flare can extend to a radius of significant size deleteriously affecting neighbors. Since the combustion is uncontrolled, the NOₓ production is at its maximum, contributing to SMOG creation in the air.

### BRIEF SUMMARY OF THE INVENTION

The present invention involves a process of collecting all the potential contaminants or pollutants in blow down conduits associated with the process units that comprise an IGCC complex, during start-up, shutdown and normal operation and treating streams containing these contaminants or pollutants such that the IGCC complex does not flare any streams containing such contaminants or otherwise emit the contaminants into the atmosphere. These potential contaminant or pollutant streams are first treated for sulfur removal, if necessary. The sulfur-free potentially contaminant or contaminant-containing streams are then segregated into either an oxidizing stream or a reducing stream.

The oxidizing or reducing streams which contain sulfur are first passed through a low pressure scrubber containing a solvent that absorbs H₂S such as either amine based or caustic-based solvent.

The reducing stream, which typically contains flammable gas with high heating value which can be greater than about 50 BTU/SCF (1869 kilojoules/scm) and oxygen content of less than about 1.0 vol %, is then passed to a vent gas combustor (“VGC”) and combusted in a controlled environment at a combustion nozzle within the VGC. The VGC is a pollution controlled combustor device with a combustion zone within a refractory lined vessel compartment, equipped with fuel nozzles designed for low nitrogen oxides (NOₓ) production. The combustion residence time is designed for optimum destruction efficiency of volatile compounds and minimization of pollutants, such as carbon monoxide (“CO”), particulates matter (“PM”), and NOₓ. For this application, other units such as an incinerator, aux boiler and duct firing with the HRSG can be used in place of the vent gas combustor. All such devices will require downstream equipment such as a selective catalytic reduction (“SCR”) reactors, having selective catalysts to minimize NOₓ, and CO catalytic oxidation reactors to reduce CO emissions and equipment to minimize PM emissions.

The oxidizing stream, which typically contains only a trace amount of flammable gas, and can contain an oxygen content of greater than about 1.0 vol %. This oxidizing stream is passed to the VGC and introduced into the VGC at a point downstream of the combustion nozzle in the combustion chamber. Both of these reducing and oxidizing streams are combusted under conditions such that the production of nitrogen oxides is reduced. These conditions include the use of commercially available low NOx burner tips that possess enhanced gas mixing features. As mentioned above, the flue gas from VGC is then passed to a catalytic unit that carries out the oxidation of carbon monoxide to carbon dioxide and a selective catalytic reduction to further reduce the nitrogen oxides content of the VGC flue gas to an acceptable level as mandated by air quality regulatory governmental agencies. The flue gas from the VGC can optionally be further cooled by heat exchange to produce steam, or by water quench to produce a cool flue gas stream leaving a stack at a significantly lower temperature than the combustion zone temperature. Such cooling reduces the heat-affected zone of the flue gas emitting from the stack more so than a heat-affected zone created by the uncontrolled combustion in a flare stack.

Further objects, features, and advantages of the present invention will become apparent from consideration of the following description and the appended claims when taken in connection with the accompanying drawings.

### BRIEF DESCRIPTION OF THE DRAWINGS

FIG. 1 is a schematic diagram of an IGCC complex flow diagram in accordance with one embodiment of the present invention, where at least one blowdown conduit is present for the syngas production zone, the shift conversion and low temperature gas cooling zones, and the acid gas removal zone.

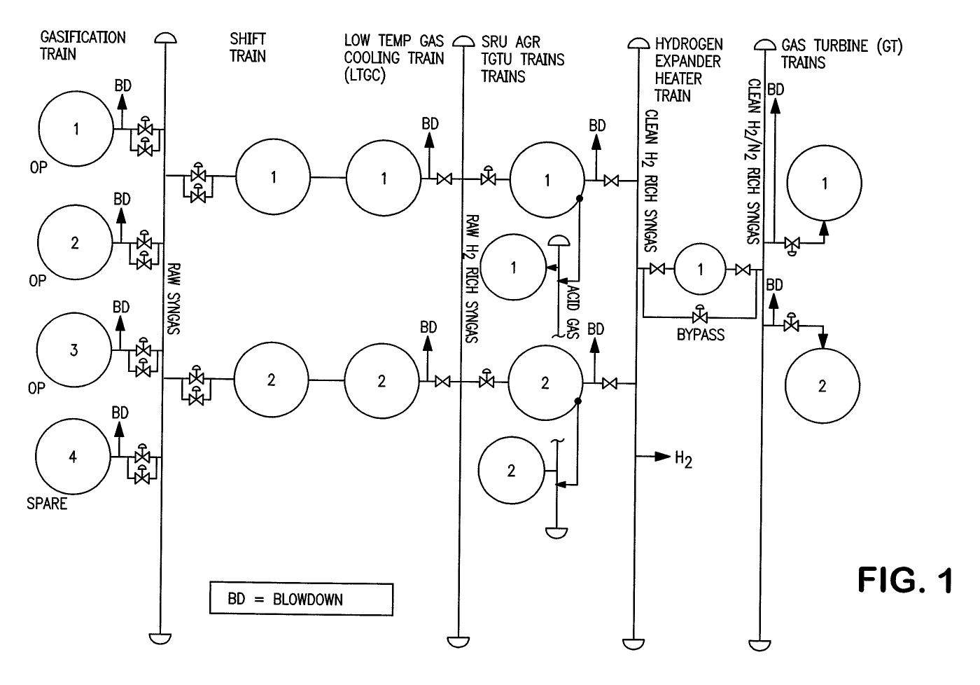

FIG. 2 is another schematic diagram of a blowdown system in accordance with one embodiment of the present invention. FIG. 2 shows the blowdown gases from the gasification zone, shift zone and low temperature gas cooling zone, acid gas recovery zone, gas turbine blow down system and blow down systems for other fugitive emission sources such as the solid handling system. FIG. 2 shows the routing of these gases depending on either the H₂S or oxygen contents.

FIG. 3 is a schematic diagram of an IGCC complex flow diagram in accordance with one embodiment of the present invention, in which at least one blowdown conduit is present for the shift conversion and low temperature gas cooling zones and the acid gas removal zone, and in which there is no blowdown conduit for the syngas production zone.

FIG. 4 is a schematic diagram of an IGCC complex flow diagram in accordance with one embodiment of the present invention, in which at least one blowdown conduit is present for the acid gas removal zone, and in which there are no blow down conduits for the syngas production zone and for the shift conversion and low temperature gas cooling zones.

FIG. 5 is a depiction of the various components of a vent gas combustor in accordance with one embodiment of the present invention.

### DETAILED DESCRIPTION OF THE INVENTION

Broadly, in accordance with the present invention the syngas production zone or gasifier in an IGCC complex is started up with a clean, sulfur-free, containing less than about 10 ppmv sulfur hydrocarbon-containing feedstock such as natural gas or a light hydrocarbon liquid such as methanol. The sulfur-free syngas produced in the gasifier, a sweet reducing gas, is then sent to a vent gas combustor having a fuel nozzle for combustion via a blow down conduit downstream of the gasifier. When the downstream acid gas removal unit and the sulfur recovery unit and the tail gas treatment unit are commissioned, the clean fuel is switched to a high sulfur solid fuel. After the AGR is fully commissioned, the acid gas (H₂S and other contaminants) are concentrated and sent to a sulfur recovery unit e.g. Claus unit to make elemental sulfur. If the acid gas concentration is less than 25% vol H₂S in the acid gas during the start-up, such acid gas is routed to a sour gas scrubber. Once the SRU is operational, the small amount of unconverted H₂S in the effluent stream of the SRU is sent to the Tail Gas Treating Unit, where the small amount of sulfur is removed, and the clean tail gas is recycled back to the AGR or to a CO₂ product stream recovered from the AGR unit for export.

The sulfur-free syngas is combusted in the VGC under an environment that includes conditions that minimize NOₓ production. The flue gas is subsequently first passed to a carbon monoxide conversion zone where CO is converted to CO₂ and then to a selective catalytic reduction unit to further reduce the NOₓ level down levels that comply with applicable local emission standards. The hot flue gas from the combustion of the sulfur-free syngas is further cooled by heat exchange to produce steam and/or by quench water spray to reduce the temperature of the flue gas substantially before eventually exiting to a VGC stack.

When the gasifier is shutdown, sour (sulfur-containing gas) gas is trapped inside the gasifier. This sour gas can be depressured in a controlled manner though a low pressure scrubber to remove the sulfur contaminants. The substantially sulfur-free depressuring gas is then sent to the VGC and combusted and treated as described above.

Generally, all emissions containing contaminants during start-up and shut down and if desired, during operation of the IGCC complex are collected in four different headers by an eductor or compressor type collection system. The gas is either scrubbed free of sulfur and then sent to the VGC, or can be recycled back to an upstream unit such as the AGR or SRU for further product (H₂, CO₂, and S) recovery. The VGC can be used during normal operation of the complex if economics dictate that recycling is not desirable.

In one embodiment of the present invention where petroleum coke is used as the hydrocarbon containing feedstock, the IGCC complex, nominally designed to procure 500 Mega Watts of power, can have three coke grinding trains, three operating plus one additional spare gasifier trains, two shift/low temperature gas cooling trains, two AGR/SRU trains, one TGTU train, one syngas expander and optionally a pressure swing absorption unit for hydrogen export offsite and two combined cycle power block trains.

Contaminant or pollutant emissions in accordance with the invention can be characterized as follows:
1) Sweet reducing gas stream—with oxygen content less than about 1 vol % and an H₂S content of less than about 50 ppmv, these streams generally emanating from all the units during start-up with a sulfur-free hydrocarbon feedstock;
2) Sour reducing gas stream—same as the stream described in item 1) except that H₂S content is greater than about 50 ppmv, these streams generally emanating from the syngas production zone and the shift conversion/low temperature gas cooling zone units after the feed to the syngas production zone is switched to the sulfur containing feed during start up or during shut down after switching to sulfur-free;
3) Sour oxidizing gas stream, e.g., having a possible oxygen content greater than about 1 vol % and an H₂S content of a greater than about 10 ppmv; these streams generally emanating from the equipment associated with the SRU that have contacted air during normal operation such as sourwater tanks, sulfur pits, etc;
4) Sweet oxidizing gas stream—same as the stream described in item 3) except that the H₂S content is less than about 10 ppmv, which streams generally emanate from the units that have contacted air during normal operation such as solids handling or solids preparation units, sumps, tanks, instrument vents and bridles and safety valves; and
5) High H₂S acid gas stream—containing greater than about 10% H₂S such as the feed to the SRU, or AGR zone.

In one embodiment of the present invention a feedstock that does not contain contaminants such as sulfur-containing compounds i.e., in amounts of about less than about 10 ppmv sulfur, is used to carry out the start up of the integrated gasification combined cycle complex. The sulfur-free feedstock which can be a hydrocarbon feedstock is passed to the syngas production zone which then produces a sweet reducing syngas effluent stream. As the gasification or syngas production zone is being started up this sweet reducing syngas stream is passed to a blow down conduit.

The sweet reducing syngas effluent stream is then passed via the blow down conduit to a vent gas combustor having a combustion nozzle. The sweet reducing syngas stream is then passed through the nozzle and combusted in the combustor under conditions that minimize the creation of nitrogen oxides to create a flue gas.

Subsequently the flue gas from the combustor is passed to a carbon monoxide catalyst zone for the removal of carbon monoxide by conversion to CO₂ using a CO oxidation catalyst and a selective catalytic reduction zone to reduce the nitrogen oxides level. The effluent from the catalytic reduction zone is then vented to the atmosphere. This flue gas from the combustor also can optionally be passed through a heat exchanger or quench column to produce steam prior catalytic treatment.

When the feed rate to the syngas production zone reaches a predetermined rate at predetermined conditions including a predetermined pressure and temperature, the syngas zone sweet reducing effluent is diverted from the blow down conduit to the shift conversion zone which typically has a low temperature gas cooling zone disposed downstream thereof. The gases passing through the shift conversion zone and the low temperature gas cooling zone and exiting the low temperature gas cooling zone and are characterized as a sweet reducing stream effluent. This sweet reducing stream effluent is then passed to a blow down conduit and combusted and treated in a VGC in the same manner as described above and ultimately released to the atmosphere.

Prior to, subsequent to, or contemporaneously with the gasifier start up, the acid gas removal zone is started up with nitrogen or any other inert gas. When the acid gas removal zone has reached predetermined operating conditions including temperature and pressure the sweet reducing gas from the blow down conduit associated with the low temperature gas cooling zone is diverted to the acid gas removal zone. The effluent from the acid gas removal zone is also characterized as a sweet reducing effluent stream. This sweet reducing stream is then passed to a blow down conduit and combusted and treated in a VGC in the same manner as described above prior to release to the atmosphere.

Prior to, subsequent to, or contemporaneously with the start-up of the upstream zones the sulfur recovery zone is started up with a start-up gas such as natural gas such that when the sulfur recovery zone has reached operating conditions. The sweet reducing effluent stream from the acid gas removal zone is then diverted from the blow down conduit buster to the sulfur recovery zone to produce another sweet reducing effluent stream. This sulfur recovery zone sweet reducing effluent stream is then passed to a tail gas treatment unit to produce a tail gas treatment unit sweet reducing effluent. The effluent from the tail gas treatment unit is then passed to a blow down conduit and combusted and treated in a VGC the same manner as described above prior to release to the atmosphere.

Subsequently the amount of sulfur-free containing feedstock to the syngas production zone is reduced and the amount of sulfur-containing hydrocarbon feed stock to the syngas production zone is increased. The acid gas removal zone sweet reducing effluent stream is diverted from the sulfur recovery zone and passed to a sour gas scrubber. The effluent from the sour gas scrubber is then passed to a combustion and treatment as described above prior to release to the atmosphere.

When the sulfur concentration of the acid gas removal effluent stream passing to the sour gas scrubber reaches a predetermined value of about 25 volume percent H₂S, this stream is diverted back to the sulfur recovery zone while simultaneously reducing start up gas to the sulfur recovery zone and increasing the sulfur laden hydrocarbon feedstock to the desired operating feed rate.

Finally the tail gas treatment unit effluent presently flowing to the VGC is diverted to a point either upstream or down stream of the acid gas removal zone.

Additionally in accordance with the present invention various sweet oxidizing gases collected from sumps, tanks, instrument vents, bridles, and pressure safety valves associated with the various zones in the IGCC complex can be passed to the above mentioned VGC(s) and introduced into the combuster at a point downstream of the nozzle.

By following the above start up procedure in accordance with this invention the IGCC complex can be started up with mitigated releases of all noxious contaminants while additionally also avoiding the deleterious effects of using flares in start up.

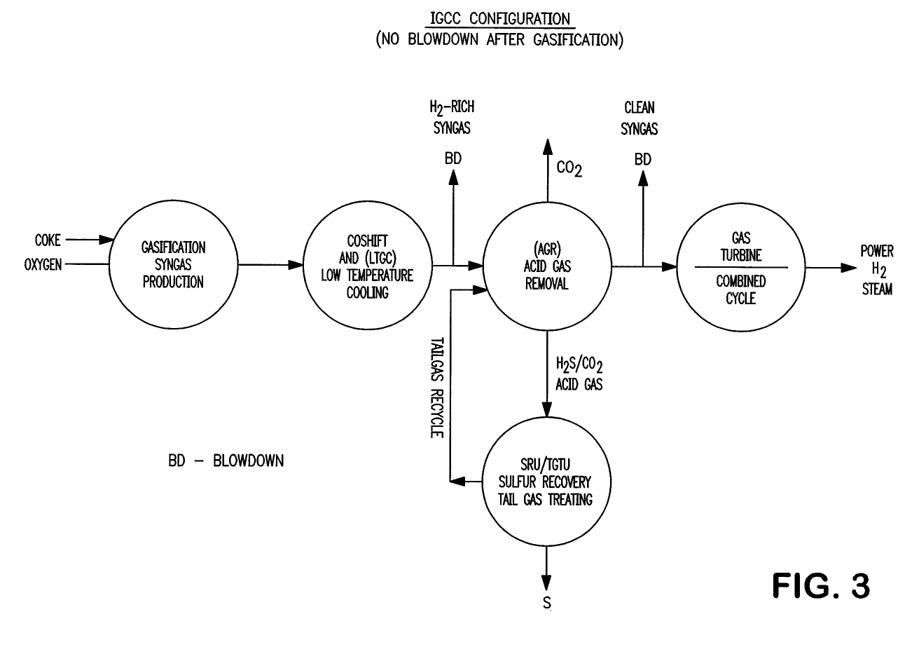

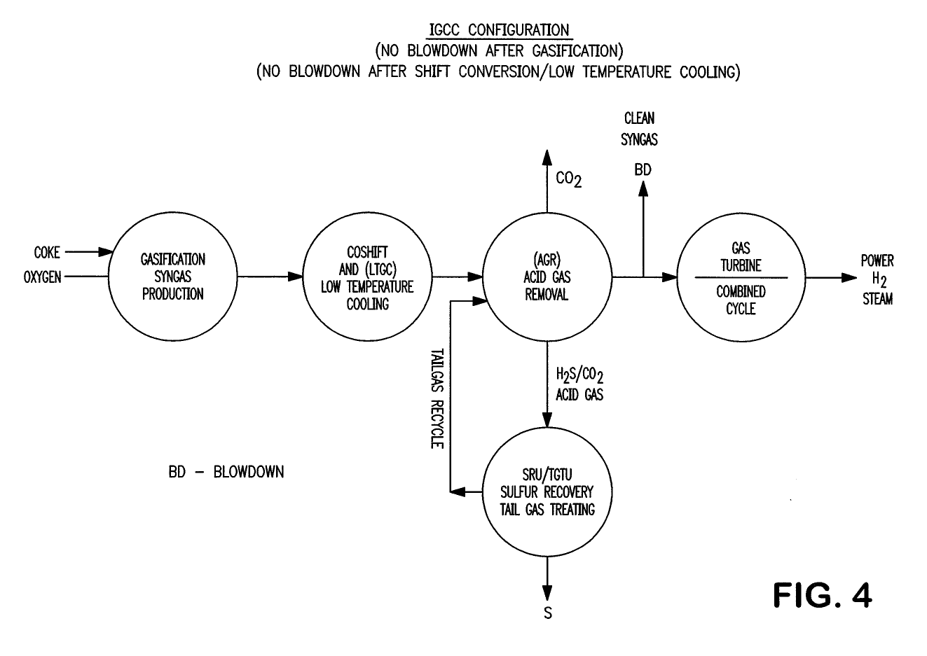

Another embodiment of the above start up procedure in accordance with the present invention involves passing the sulfur-free start up feedstock through the syngas production and the shift conversion zone including the low temperature gas cooling zone prior sending it to a blow down conduit for combustion and treatment. FIG. 3 depicts a schematic process flow diagram that would permit this type of start up. In yet another embodiment of the start-up procedure the sulfur free start up feedstock is passed through the syngas production zone, the shift conversion zone, low temperature gas cooling zone and the acid gas removal zone prior to sending it to a blow down conduit for combustion and treatment. FIG. 4 depicts a schematic process flow diagram that would permit this type of start up.

Another embodiment of the present invention provides for a process for shutting down an integrated gasification combined cycle complex with out flaring and mitigating the release of noxious contaminants such as sulfur. More specifically in the shut down procedure the feedstock to the syngas production zone is switched to a sulfur-free, i.e. about less than 10 ppmv sulfur, feedstock. Once the syngas stream using the sulfur laden hydrocarbon feedstock is displaced by the syngas using the sulfur free feedstock, the effluent from the syngas production zone now a sweet reducing gas is diverting from the shift conversion zone and depressurized to a blow down conduit associated with the syngas production zone. The effluent from the syngas production zone is then passed to a vent gas combustor for combustion and treatment as described above prior to release to the atmosphere.

Subsequently, the effluent from the low temperature gas cooling zone associated with the shift conversion zone is diverted from the acid gas removal zone and depressurized to a blow down conduit associated with the shift conversion zone. This effluent stream is then passed to a vent gas combustor for combustion and treatment of the gases in accordance with the present invention prior to release to the atmosphere.

The effluent from the acid gas reduction zone is then depressurized. Specifically the hydrogen rich syngas is passed to a vent gas combustor to be combusted and treated in accordance with the present invention prior to release to the atmosphere. The acid gas is depressurized to the sulfur recovery zone.

The gaseous effluent from the sulfur recovery zone is depressurized to a tail gas treating unit.

The effluent from the tail gas treating unit is diverted from its recycle to the acid gas removal zone and is depressurized to a vent gas combustor for combustion and treatment in accordance with the present invention.

Finally the fuel to the turbines in the power block zone is switched from hydrogen to natural gas.

In another embodiment the gasifier and shift zone can both be depressurized by diverting the sweet reducing effluent stream from the low temperature cooling zone to the vent gas combustor, with the remainder of the IGCC complex being shut down as described above.

In another embodiment of the present invention is to provide for a process for shutting down an integrated gasification combined cycle complex without flaring and mitigating the release of noxious contaminants such as sulfur in a manner that does not use a sulfur-free feedstock as described above. The effluent from the syngas production zone now a sour reducing gas is diverted from the shift conversion zone and depressurized to a blow down conduit associated with the syngas production zone. The effluent from the syngas production zone is then slowly discharged to a low pressure sour gas scrubber (such as an amine scrubber) for sulfur removal by throttling one or more pressure control valves. The effluent from the sour gas scrubber is passed to a vent gas combustor for combustion and treatment as described above prior to release to the atmosphere.

Subsequently, the effluent from the low temperature gas cooling zone associated with the shift conversion zone is diverted from the acid gas removal zone and depressurized to a blow down conduit associated with the shift conversion zone. This sour reducing effluent stream is then slowly discharged to a low pressure scrubber by throttling one or more pressure control valves. The effluent from the low pressure scrubber is passed to a vent gas combustor for combustion and treatment of the gases in accordance with the present invention prior to release to the atmosphere.

The effluent from the acid gas reduction zone is then depressurized. Specifically the hydrogen rich syngas is passed to a vent gas combustor to be combusted and treated in accordance with the present invention prior to release to the atmosphere. The acid gas effluent is depressurized to the sulfur recovery zone.

The gaseous effluent from the sulfur recovery zone is depressurized to a tail gas treating unit.

The effluent from the tail gas treating unit is diverted from its recycle to the acid gas removal zone and is depressurized to a vent gas combustor for combustion and treatment in accordance with the present invention.

Finally the fuel to the turbines in the power block zone is switched from hydrogen to natural gas.

In another embodiment the gasifier and shift zone can both be depressurized by diverting the sour reducing effluent stream from the low temperature cooling zone to a low pressure scrubber and then to the vent gas combustor, with the remainder of the IGCC complex being shut down as described above.

In yet another embodiment the gasifier, shift and acid gas removal zones can be depressurized by commencing the acid removal zone shut down as described above and not depressurizing the gasifier and shift individually prior to the depressurization of the acid gas removal zone as described above.

For the purposes of this invention the tail gas treating unit comprises of the following components and operates as described below.

In this invention, the tail gas treatment unit can contain either one standard amine absorber for both normal operations and gasifier shutdown operations or two amine absorbers one dedicated for gasifier shutdown and the other for normal operating conditions. The TGTU unit also contains several exchangers, pumps, filters and a stripping column. The TGTU amine absorber is used to remove the H₂S in the TGTU feed. The H₂S is absorbed in the amine and the rich amine (H₂S laden amine solvent) is regenerated to an essentially sulfur free amine by stripping the rich amine with steam in the stripping column or regenerator. This regenerated amine is reused in the TGTU process and the H₂S from the stripping process is recycled back to the sulfur recovery unit for further sulfur removal

The start-up hydrocarbon-containing feedstock or fuel that is free of sulfur can be natural gas or light hydrocarbon liquid such as methanol. The start-up fuel rate can be less than or, for instance, about 10% to more than 50% of the normal operating condition (“NOC”) of one gasifier throughput. As the gasifier pressure is increased, the rest of the gasification system is commissioned.

For instance, when the methanol and oxygen mixture is first ignited in the gasifier, the pressure will rapidly increase to 50-150 psig (345-1034 kPa) within minutes after the lightoff with a pressure control valve opened and adjusted to produce such a backpressure. The blow down syngas is routed to the sweet reducing gas header to the VGC fuel nozzles. A water knockout drum at the inlet of the VGC is necessary to remove any condensed moisture from the wet syngas mixture at start-up. The gasifier pressure is gradually increased by throttling the pressure control valve to the blowdown stream. The water in the syngas includes the equilibrium water at the gasifier operating pressure and any water physically entrained by the syngas flow. As mentioned in one embodiment, the blow down gas is sent to the VGC. The header pressure of the VGC is maintained by the back pressure of VGC burner design, perhaps less than 5 psig (34.5 KPa) at this low start-up rate. In order to keep the gasification system gas velocity roughly constant during start-up, the ramp up schedule of the gasifier start-up can be as follows:
Hold pressure at about 150 psig (1034 KPa) and about 20% NOC for about 1 hour to check leak and tighten flanges;
Increase the gasifier venting pressure to about 200 psig (1379 KPa) at about 20% NOC;
Increase the gasifier throughput by about 1%/minute and adjust the pressure of the gasifier accordingly, e.g., about 30% NOC at about 300 psig (2068 KPa), about 40% NOC at about 400 psig (2758 KPa), etc. It can take about 1 hour to reach about 70% NOC and about 700 psig (4826 KPa) pressure;
When the gasifier throughput reaches about 70% NOC at about 700 psig (4826 KPa), the pressure can be increased at a rate of about 15 psi (103 KPa)/minute until the gasifier pressure reaches the NOC operating pressure (e.g. about 1000 psig (6895 KPa);
Alternatively, for the first gasifier/shift/low temperature gas cooling Acid Gas Removal train start-up, if the AGR can be operated at a reduced pressure and a reduced throughput, the gasifier pressure and throughput can be ramped up to only about 40% NOC throughput at about 400 psig (2758 KPa) for the AGR start-up to save start-up fuel and oxygen. This 40% minimum turndown is based on the constraints provided by a typical AGR column design;
As the gasifier pressure is increased, the rest of the gasification black water flash system is commissioned (the term “black water” designates the water stream from the gas/water scrubber used to remove particulates from the gasifier which is subsequently flashed to remove any dissolved gases); and
Ramping the gasifier pressure at 50-100% NOC to 100 (689.5 KPa)-1300 psig (8963 KPa). and lining out the unit, it should take less than a total of about 4 hours to reach the state NOC at full gasifier operating pressure before introducing gas to the shift section.

The syngas from the gasification zone is introduced to the shift section and the low temperature gas cooling (“LTGC”) section. The syngas from the gasification zone syngas scrubber overhead is diverted from the vent gas combustor and introduced to the shift zone and the LTGC zone by first opening the small equalizing valve at the inlet of the shift zone gradually to equalize the upstream and downstream pressure. After the pressure is equalized, then a control valve can be gradually opened to introduce more syngas to the shift zone and downstream. Simultaneously, the pressure control valve controlling the venting of the sweet syngas to the blowdown conduit passing to the VGC can be gradually closed as more syngas is introduced to downstream section.

The introduction of syngas to the acid gas removal is performed similar to the introduction of syngas to the shift/LTGC zones. The scrubbed and shifted syngas passing through the AGR zone should be routed to the VGC at a blow down conduit located at the outlet of the H₂ rich syngas in the AGR. Any CO₂ stream from the AGR unit can be vented to the atmosphere using a CO₂ vent stack. The AGR sweet acid gas is then sent to the Sulfur Recovery Unit (“SRU”). The SRU can be started up with supplementary firing using natural gas because the sweet acid gas contains practically no H₂S. The SRU refractory heat up is estimated to take at least about 16 to about 24 hours to complete. The SRU should reach steady-state operation such that it is ready to receive sour acid gas. The effluent from the TGTU low pressure amine scrubber contains mainly CO₂ and is vented to a location downstream of the VGC combustor burner during this start-up period

The switching of the sulfur-free startup fuel to coke slurry feed can be performed after the AGR/SRU have reached steady-state operation. The composition of the vented syngas at the AGR will change slightly after the fuel switching. However, the switching of the sweet to sour acid gas to the SRU can be done over about a 30 minute to about one hour period. The sour acid reducing gas coming from the AGR is first routed to a low pressure (“LLP”) scrubber and then to the vent gas combustor burner and then switched gradually to the SRU burner. Such switching of flow to the SRU burner is carried out while simultaneously reducing the start-up natural gas supply to the SRU.

After switching the fuel from clean sulfur-free natural gas or hydrocarbon liquid to coke slurry feed, the AGR acid gas H₂S concentration will steadily increase. The SRU operation is then adjusted to normal operating conditions by feeding H₂S acid gas from the AGR and NH₃ from a sour water stripper to the SRU. The TGTU tail gas from the low pressure amine scrubber overhead is first sent to the VGC combustor downstream of the VGC fuel nozzle. When the H₂S content in the scrubbed TGTU tail gas is verified to be acceptable, i.e., less than ppmv 10 ppmv, the tail gas compressor can then be started up in order to route the tail gas to the product CO₂ stream or alternatively, if the H₂S content is too high, it can be routed to a point upstream of the AGR. The CO₂ stream from the AGR is routed to the CO₂ pipeline for sales or EOR.

The clean H₂ rich syngas can also be routed downstream using the expander bypass line to vent at the gas turbine inlet after the gasifier lightoff. The pressure control valve on an expander bypass can be used to automatically control the expander upstream pressure and the pressure control valve on the blowdown conduit to the VGC can be used to automatically control the expander downstream pressure to the gas turbine.

For a planned shutdown, the shutdown actions can generally be carried out by reversing the steps of the start-up procedure. The gasifier throughput is reduced, e.g., from about 100% to about 70% at its normal operating pressure, and the fuel can be switched from coke slurry to a sulfur-free feedstock such as methanol. The gas turbine can be backed down commensurately. After switching the fuel to the gasifier, the syngas scrubber overhead control valve can be gradually closed, with the pressure control valve opened gradually to vent to the sweet reducing gas blowdown header passing to the VGC. As the syngas is vented, the gasifier throughput is reduced simultaneously to minimize venting. When the syngas scrubber overhead control valves are completely closed, the clean syngas is 100% routed to the VGC. The pressure and the throughput of the gasifier operating on the clean fuel can be gradually reduced until an arbitrary low throughput is achieved and a reduced gasifier pressure (for example, 50% NOC at 500 psig (3447 KPa) gasifier pressure) is established. The gasifier shutdown sequence is then initiated to shutdown the gasifier in a controlled manner.

When the gasifier shutdown sequence is initiated to shutdown the gasifier in a controlled manner, the syngas system is bottled up at operating pressure. The gasifier will be depressured gradually through the gasifier blowdown conduit to the VGC. The flow rate of the syngas to the VGC due to depressurizing can be calculated by the reduction of inventory accordingly. After the syngas depressuring, the system can be nitrogen purged. The shutdown nitrogen purge is also sent to the VGC as well via the gasifier blowdown conduit.

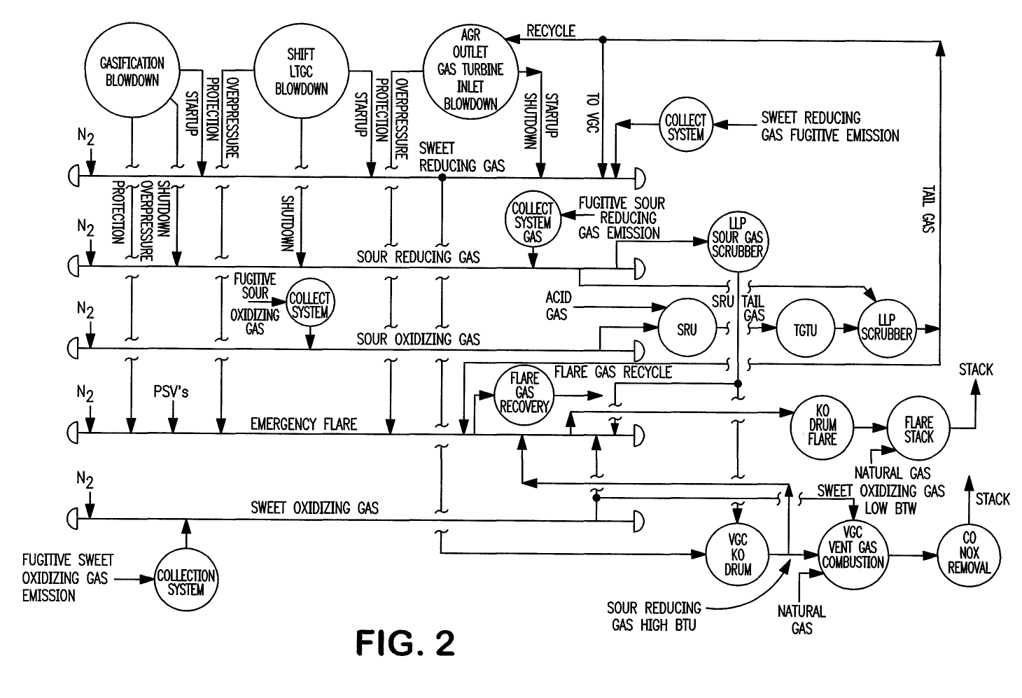

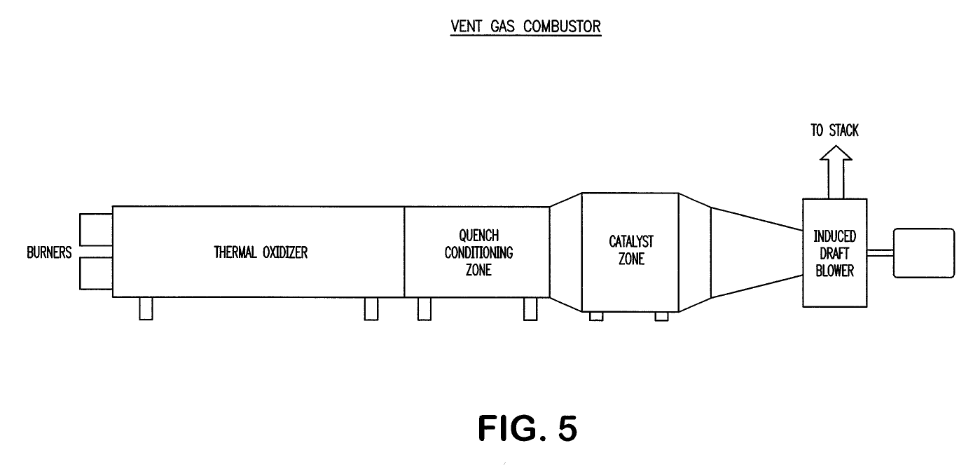

The pollution control equipment includes all equipment and flow schemes shown in FIG. 2. For example, the relief or blow down gases are segregated into various relief headers according to whether the gases contain H₂S and oxygen, as described previously. If an emergency flare is used, a recovery system is included to recover any usable gases such as H₂, CO₂ or sulfur for sales, a ground flare is used for emergency safety relief and the vent gas combustor for shutdown and start-up operations. Additionally, CO oxidation catalysts and a selective catalytic reaction catalyst are used for CO conversion to CO₂ and NOₓ reduction, respectively. The sour gas scrubbers is used for H₂S removal in the startup/shutdown cases and in emergency acid gas release. FIG. 5 depicts a specific configuration of components of a vent gas combustor. Specifically, the “thermal oxidizer” is the combustion zone. The “quench conditioning zone” is a zone where heat can be recovered from the vent gases during start-up, operation or shut down. The “catalyst zone” is where the CO oxidation and NOx reduction take place. The “induced draft blower” is where air is blown in with the vent gases to push tem up the stack. The following is a non-exclusive example list of the pollution control equipment that may be used in an IGCC complex to carry out an embodiment of the present invention:
Vent Gas Combustor, Aux Boiler, Incinerator or Duct firing with HRSG (of these units will generally have an SCR downstream)
Ground Flare (safety equipment, not pollution control equipment)
LLP Emergency Reducing Sour Gas Scrubber (amine or caustic)
LP Sour Gas Scrubber (TGTU MDEA absorber)
Flare Gas Recovery System (sour gas recycle compressor)
TGTU Tail Gas Compressor
Flare Knockout Drum
VGC Knockout Drum
Oxidizing Sour Gas Fugitive Emission Collector (eductor) System
Reducing Sour Gas Fugitive Emission Collector (eductor or compressor) System
Oxidizing Sweet Gas Fugitive Emission Collector (eductor or aspirator) System
Reducing Sweet Gas Fugitive Emission Collector (eductor or compressor) System
Gas Turbine/HRSG Pollution Control Systems

When pollution-control equipment is all operating properly, the sour gas coming from in the SRU tailgas is scrubbed and the clean TGTU tail gas is recycled back to upstream of the CO₂ compressors.

While the present invention has been described in terms of preferred embodiments, it will be understood, of course, that the invention is not limited thereto since modifications may be made by these skilled in the art, particularly in light of the foregoing teachings.

What is claimed is:

1. A process for starting up an integrated gasification combined cycle complex wherein the integrated gasification combined cycle complex comprises a syngas production zone, shift conversion reaction zone, acid gas removal zone, sulfur recovery zone and a combined cycle power block zone, wherein each zone has at least one blow down conduit associated with it, wherein the integrated gasification combined cycle complex is started up with a hydrocarbon-containing feedstock not containing contaminants such as sulfur-containing compounds and wherein said starting up is carried out with out flaring or otherwise releasing untreated contaminant emissions which process comprises the steps of:
(a) recovering a sweet reducing effluent stream from an applicable zone being started up in the integrated gasification combined cycle complex;
(b) passing the sweet reducing effluent stream from the applicable zone that is being started up through at least one blow down conduit downstream of the applicable zone;
(c) passing the sweet reducing stream recovered from the blow down conduit in step (b) to a vent gas combustor having a combustion nozzle and passing the sweet reducing gas through the nozzle and combusting the reducing gas in the combustor under conditions that minimize the creation of nitrogen oxides to create a flue gas; and
(d) passing the flue gas from the combustor to a carbon monoxide catalyst zone for the removal of carbon monoxide and a selective catalytic reduction zone to reduce the nitrogen oxides level.

2. The process of claim 1 wherein the effluent from the vent gas combustor is passed to a heat exchanger or quench column to produce steam thereby cooling the effluent.

3. The process of claim 1 wherein sweet oxidizing streams are collected from the group consisting of sumps, tanks, instrument vents, bridals, and pressure safety valves associated with the various zones in the integrated gasification combined cycle complex and such sweet oxidizing streams are passed to the combustor and introduced into the combustor at a point downstream of the nozzle.

4. The process of claim 1 which process further comprises the steps of:
(a) passing a sulfur-free hydrocarbon feedstock to the syngas production zone to produce a sweet reducing syngas effluent stream;
(b) passing the sweet reducing syngas effluent stream to a blow down conduit;
(c) passing the sweet reducing stream from the blow down conduit in step (b) to a vent gas combustor having a combustion nozzle and passing the reducing gas through the nozzle and combusting the reducing gas in the combustor under conditions that minimize the creation of nitrogen oxides to create a flue gas;
(d) passing the flue gas from the combustor to a carbon monoxide catalyst zone for the removal of carbon monoxide and a selective catalytic reduction zone to reduce the nitrogen oxides level and then venting the effluent from the catalytic reduction zone to the atmosphere;
(e) when the feed rate to the syngas production zone reaches a predetermined rate at predetermined conditions including a predetermined pressure and temperature, the syngas zone sweet reducing effluent stream is diverted from the blow down conduit in step (b) to the shift conversion zone having a low temperature gas cooling zone downstream thereof to produce a sweet reducing stream effluent from the low temperature gas cooling zone;
(f) passing the sweet reducing stream effluent from the low temperature gas cooling zone to a blow down conduit downstream of the low temperature gas cooling zone;
(g) passing the sweet reducing stream from the blow down conduit in step (f) to a vent gas combustor having a combustion nozzle and passing the reducing gas through the nozzle and combusting the reducing gas in the combustor under conditions that minimize the creation of nitrogen oxides to create a flue gas;
(h) passing the flue gas from the combustor to a carbon monoxide catalyst zone for the removal of carbon monoxide and a selective catalytic reduction zone to reduce the nitrogen oxides level and then venting the effluent from the catalytic reduction zone to the atmosphere;
(i) starting up the acid gas removal zone with nitrogen or any other inert gas such that when the acid gas removal zone has reached predetermined operating conditions including temperature and pressure the sweet reducing stream effluent from the blow down conduit associated with the low temperature gas cooling zone in step (f) is diverted to the acid gas removal zone to produce a sweet reducing effluent stream;
(j) passing the sweet reducing effluent stream from the acid gas removal zone in step (i) to a blow down conduit down stream of the acid gas removal zone;
(k) passing the sweet reducing stream from the blow down conduit in step (j) to a vent gas combustor having a combustion nozzle and passing the reducing gas through the nozzle and combusting the reducing gas in the combustor under conditions that minimize the creation of nitrogen oxides to produce a flue gas;
(l) passing the flue gas from the combustor to a carbon monoxide catalyst zone for the removal of carbon monoxide and a selective catalytic reduction zone to reduce the nitrogen oxides level and then venting the effluent from the catalytic reduction zone to the atmosphere;
(m) starting up the sulfur recovery zone with a start-up gas such as natural gas such that when the sulfur recovery zone has reached operating conditions the sweet reducing effluent stream from the acid gas removal zone is diverted from the blow down conduit in step (j) to the sulfur recovery zone to produce a sweet reducing effluent stream;
(n) passing the sulfur recovery zone sweet reducing effluent to a tail gas treatment unit to produce a tail gas treatment unit sweet reducing effluent;
(o) passing the tail gas treatment unit sweet reducing effluent to a vent gas combustor having a combustion nozzle and passing the reducing gas through the nozzle and combusting the reducing gas in the combustor under conditions that minimize the creation of nitrogen oxides to produce a flue gas;
(p) passing the flue gas from the combustor to a carbon monoxide catalyst zone for the removal of carbon monoxide and a selective catalytic reduction zone to reduce the nitrogen oxides level and then venting the effluent from the catalytic reduction zone to the atmosphere;
(q) reducing the amount of sulfur-free containing feedstock to the syngas production zone and passing a sulfur-containing hydrocarbon feed stock to the syngas production zone;
(r) diverting the acid gas removal zone sweet reducing effluent stream from the sulfur recovery zone to sour a gas scrubber;
(s) passing the effluent from the sour gas scrubber to a vent gas combustor having a combustion nozzle and passing the reducing gas through the nozzle and combusting the reducing gas in the combustor under conditions that minimize the creation of nitrogen oxides to produce a flue gas;
(t) passing the flue gas from the combustor to a carbon monoxide catalyst zone for the removal of carbon monoxide and a selective catalytic reduction zone to reduce the nitrogen oxides level and then venting the effluent from the catalytic reduction zone to the atmosphere;
(u) when the sulfur concentration of the acid gas removal effluent stream passing to the sour gas scrubber reaches a predetermined value, the stream is diverted back to the sulfur recovery zone while simultaneously reducing start up gas to the sulfur recovery zone;
(v) diverting the tail gas treatment unit effluent presently flowing to the combustor in step (o) to a point either upstream or down stream of the acid gas removal zone.

5. The process of claim 1 which process further comprises the steps of:
(a) passing a sulfur-free hydrocarbon feedstock to the syngas production zone to produce a sweet reducing syngas effluent stream;
(b) passing the sweet reducing syngas effluent stream to the shift conversion zone having a low temperature gas cooling zone downstream thereof to produce a sweet reducing stream effluent from the low temperature gas cooling zone;
(c) passing the shift conversion zone effluent sweet reducing stream from the low temperature gas cooling zone to a blow down conduit downstream of the low temperature gas cooling zone;
(d) passing the sweet reducing stream from the blow down conduit in step (c) to a vent gas combustor having a combustion nozzle and passing the reducing gas through the nozzle and combusting the reducing gas in the combustor under conditions that minimize the creation of nitrogen oxides to create a flue gas;
(e) passing the flue gas from the combustor to a carbon monoxide catalyst zone for the removal of carbon monoxide and a selective catalytic reduction zone to reduce the nitrogen oxides level and then venting the effluent from the catalytic reduction zone to the atmosphere;
(f) starting up the acid gas removal zone with nitrogen or any other inert gas such that when the acid gas removal zone has reached predetermined operating conditions including appropriate temperature and pressure, the sweet reducing stream effluent from the blow down conduit associated with the low temperature gas cooling zone is diverted to the acid gas removal zone to produce a sweet reducing effluent stream;
(g) passing the sweet reducing effluent stream from the acid gas removal zone to a blow down conduit down stream of the acid gas removal zone;
(h) passing the sweet reducing stream from the blow down conduit in step (g) to a vent gas combustor having a combustion nozzle and passing the reducing gas through the nozzle and combusting the reducing gas in the combustor under conditions that minimize the creation of nitrogen oxides to produce a flue gas;
(i) passing the flue gas from the combustor to a carbon monoxide catalyst zone for the removal of carbon monoxide and a selective catalytic reduction zone to reduce the nitrogen oxides level and then venting the effluent from the catalytic reduction zone to the atmosphere;
(j) starting up the sulfur recovery zone with a start-up gas such as natural gas such that when the sulfur recovery zone has reached operating conditions, the sweet reducing effluent stream from the acid gas removal zone is diverted from the blowdown conduit in step (g) to the sulfur recovery zone to produce a sweet reducing effluent stream;
(k) passing the sulfur recovery zone sweet reducing effluent to a tail gas treatment unit to produce a tail gas treatment unit sweet reducing effluent;
(l) passing the tail gas treatment unit reducing gas effluent to a vent gas combustor having a combustion nozzle and passing the reducing gas through the nozzle and combusting the reducing gas in the combustor under conditions that minimize the creation of nitrogen oxides to produce a flue gas;
(m) passing the flue gas from the combustor to a carbon monoxide catalyst zone for the removal of carbon monoxide and a selective catalytic reduction zone to reduce the nitrogen oxides level and then venting the effluent from the catalytic reduction zone to the atmosphere;
(n) reducing the amount of sulfur-free containing feedstock to the syngas production zone and passing a sulfur-containing hydrocarbon feed stock to the syngas production zone;
(o) diverting the acid gas removal zone reducing effluent stream from the sulfur recovery zone to a sour gas scrubber;
(p) passing the effluent from the sour gas scrubber to a vent gas combustor having a combustion nozzle and passing the reducing gas through the nozzle and combusting the reducing gas in the combustor under conditions that minimize the creation of nitrogen oxides to produce a flue gas;
(q) passing the flue gas from the combustor to a carbon monoxide catalyst zone for the removal of carbon monoxide and a selective catalytic reduction zone to reduce the nitrogen oxides level and then venting the effluent from the catalytic reduction zone to the atmosphere;
(r) when the sulfur concentration of the acid gas removal effluent stream passing to the sour gas scrubber reaches a predetermined value, the stream is diverted back to the sulfur recovery zone while simultaneously reducing start up gas to the sulfur recovery zone; and
(s) diverting the tail gas from the tail gas treatment unit effluent presently flowing to the combustor in step (l) to a point either upstream or down stream of the acid gas recovery zone.

6. The process of claim 1 which process further comprises the steps of:
(a) passing a sulfur-free hydrocarbon feedstock to the syngas production zone to produce a sweet reducing syngas effluent stream;
(b) passing the sweet reducing syngas effluent stream to a shift conversion zone having a low temperature gas cooling zone downstream thereof to produce a sweet reducing effluent stream;
(c) passing the sweet reducing stream effluent from the low temperature gas cooling zone to the acid gas zone to produce a sweet reducing gas effluent stream;
(d) passing the sweet reducing gas effluent from the acid gas removal zone to a blow down conduit down stream of the acid gas removal zone;
(e) passing the sweet reducing stream from the blow down conduit to a vent gas combustor having a combustion nozzle and passing the reducing gas through the nozzle and combusting the reducing gas in the combustor under conditions that minimize the creation of nitrogen oxides to produce a flue gas;
(f) passing the flue gas from the combustor to a carbon monoxide catalyst zone for the removal of carbon monoxide and a selective catalytic reduction zone to reduce the nitrogen oxides level and then venting the effluent from the catalytic reduction zone to the atmosphere;
(g) starting up the sulfur recovery zone with a start-up gas such as natural gas such that when the sulfur recovery zone has reached operating conditions, the sweet reducing effluent stream from acid gas removal zone is diverted from the blown down conduit in step (d) to the sulfur recovery zone to produce a sweet reducing effluent stream;
(h) passing the sulfur recovery zone sweet reducing effluent stream to a tail gas treatment unit to produce a tailgas treatment unit sweet reducing effluent;
(i) passing the tail gas treatment unit reducing gas effluent to a vent gas combustor having a combustion nozzle and passing the reducing gas through the nozzle and combusting the reducing gas in the combustor under conditions that minimize the creation of nitrogen oxides to produce a flue gas;
(j) passing the flue gas from the combustor to a carbon monoxide catalyst zone for the removal of carbon monoxide and a selective catalytic reduction zone to reduce the nitrogen oxides level and then venting the effluent from the catalytic reduction zone to the atmosphere;
(k) reducing the amount of sulfur-free containing feedstock to the syngas production zone and passing a sulfur-containing hydrocarbon feed stock to the syngas production zone;
(l) diverting the acid gas removal regenerator sweet reducing effluent stream from the sulfur recovery zone to a sour gas scrubber;
(m) passing the effluent from the sour gas scrubber to a vent gas combustor having a combustion nozzle and passing the reducing gas through the nozzle and combusting the reducing gas in the combustor under conditions that minimize the creation of nitrogen oxides to produce a flue gas;
(n) passing the flue gas from the combustor to a carbon monoxide catalyst zone for the removal of carbon monoxide and a selective catalytic reduction zone to reduce the nitrogen oxides level and then venting the effluent from the catalytic reduction zone to the atmosphere;
(o) when the sulfur concentration of the acid gas removal effluent stream passing to the sour gas scrubber reaches a predetermined value, the stream is diverted back to the sulfur recovery zone while simultaneously reducing start-up gas to the sulfur recovery zone; and
(p) diverting the tail gas from the tail gas treatment unit effluent presently flowing to the combustor in step (i) to a point either upstream or down stream of the acid gas removal zone.

7. A process for shutting down an integrated gasification combined cycle complex wherein the integrated gasification combined cycle complex comprises a syngas production zone, shift conversion reaction zone, low temperature gas cooling zone, acid gas removal zone, sulfur recovery zone and a combined cycle power block zone, wherein each zone has at least one blow down conduit associated with it wherein the complex is being fed a hydrocarbon-containing feedstock which feedstock contains contaminants such as sulfur, wherein the process comprises the steps of:
(a) switching the feedstock to the syngas production zone to a sulfur-free hydrocarbon containing feedstock such that a sweet reducing stream effluent is created once the syngas from the sulfur-free feedstock displaces the sulfur-containing feedstock.
(b) diverting and depressurizing the sweet reducing stream effluent from the syngas production zone passing to the shift conversion zone to a blow down conduit associated with the syngas production zone;
(c) passing the effluent from the syngas production zone in step (b) to a vent gas combustor having a combustion nozzle and passing the reducing gas through the nozzle and combusting the reducing gas in the combustor under conditions that minimize the creation of nitrogen oxides to create a flue gas;
(d) passing the flue gas from the combustor to a carbon monoxide catalyst zone for the removal of carbon monoxide and a selective catalytic reduction zone to reduce the nitrogen oxides level and then venting the effluent from the catalytic reduction zone to the atmosphere;
(e) diverting and depressurizing the low temperature gas cooling sour reducing zone effluent passing to the acid gas removal zone to a blowdown conduit associated with the shift conversion zone and low temperature gas cooling zone;
(f) passing the effluent from the shift conversion zone and low temperature gas cooling zone in step (e) to a vent gas combustor having a combustion nozzle and passing the reducing gas through the nozzle and combusting the reducing gas in the combustor under conditions that minimize the creation of nitrogen oxides to create a flue gas;
(g) passing the flue gas from the combustor in step (f) to a carbon monoxide catalyst zone for the removal of carbon monoxide and a selective catalytic reduction zone to reduce the nitrogen oxides level and then venting the effluent from the catalytic reduction zone to the atmosphere; and
(h) diverting and depressurizing the effluent from the acid gas reduction zone as follows:
i. passing a hydrogen rich syngas to a vent gas combustor;
ii. passing the acid gas to the sulfur recovery zone;
(i) depressurizing the sulfur recovery zone to a tail gas treating unit absorber;
(j) passing the effluent from the tail gas treatment unit absorber to a vent gas combustor having a combustion nozzle and passing the reducing gas through the nozzle and combusting the reducing gas in the combustor under conditions that minimize the creation of nitrogen oxides to create a flue gas;
(k) passing the flue gas from the combustor in step (j) to a carbon monoxide catalyst zone for the removal of carbon monoxide and a selective catalytic reduction zone to reduce the nitrogen oxides level and then venting the effluent from the catalytic reduction zone to the atmosphere; and
(l) switching the fuel to turbines associated with the power block zone from hydrogen to natural gas.

8. The process of claim 7 which process further comprises the steps of:
(a) switching the feedstock to the syngas production zone to a sulfur-free hydrocarbon-containing feedstock;
(b) diverting and depressurizing a sweet reducing stream effluent from the temperature gas cooling zone to the blow down conduit associated with this zone once the sulfur-free syngas from the sulfur-free feedstock displaces the syngas from the sulfur-containing feedstock in syngas production zone;
(c) passing the effluent from the low temperature gas cooling zone in step (b) to a vent gas combustor having a combustion nozzle and passing the reducing gas through the nozzle and combusting the reducing gas in the combustor under conditions that minimize the creation of nitrogen oxides to create a flue gas;
(d) passing the flue gas from the combustor to a carbon monoxide catalyst zone for the removal of carbon monoxide and a selective catalytic reduction zone to reduce the nitrogen oxides level and then venting the effluent from the catalytic reduction zone to the atmosphere;
(e) diverting and depressurizing the effluent from the acid gas removal zone as follows:
(i) passing a hydrogen rich syngas to a vent gas combustor;
(ii) passing the acid gas to the sulfur recovery zone;
(f) depressurizing the sulfur recovery zone to a tail gas treating unit (“TGTU”) absorber;
(g) passing the effluent from the low pressure tail gas treatment unit absorber to a vent gas combustor having a combustion nozzle and passing the reducing gas through the nozzle and combusting the reducing gas in the combustor under conditions that minimize the creation of nitrogen oxides to create a flue gas;
(h) passing the flue gas from the combustor in step (g) to a carbon monoxide catalyst zone for the removal of carbon monoxide and a selective catalytic reduction zone to reduce the nitrogen oxides level and then venting the effluent from the catalytic reduction zone to the atmosphere; and
(i) switching the fuel to turbines associated with the power block zone from hydrogen to natural gas.

9. The process of claim 7 which process further comprises the steps of:
(a) switching the feedstock to the syngas production zone to a sulfur-free hydrocarbon containing feedstock;
(b) diverting and depressurizing the sweet reducing stream effluent from the acid gas removal zone as follows:
i) passing a hydrogen rich syngas to a vent gas combustor;
ii) passing the acid gas to the sulfur recovery zone;
(c) depressurizing the sulfur recovery zone to a tail gas treating unit absorber;
(d) passing the effluent from the low pressure tail gas treatment unit absorber to a vent gas combustor; a vent gas combustor having a combustion nozzle and passing the reducing gas through the nozzle and combusting the reducing gas in the combustor under conditions that minimize the creation of nitrogen oxides to create a flue gas;
(e) passing the flue gas from the combustor in step (d) to a carbon monoxide catalyst zone for the removal of carbon monoxide and a selective catalytic reduction zone to reduce the nitrogen oxides level and then venting the effluent from the catalytic reduction zone to the atmosphere; and
(f) switching the fuel to turbines associated with the power block zone from hydrogen to natural gas.

10. A process for shutting down an integrated gasification combined cycle complex wherein the integrated gasification combined cycle complex comprises a syngas production zone, shift conversion reaction zone, low temperature gas cooling zone, acid gas removal zone, sulfur recovery zone and a combined cycle power block zone, wherein each zone has at least one blow down conduit associated with it wherein the complex is being fed a hydrocarbon-containing feedstock which feedstock contains contaminants such as sulfur, wherein the process comprises the steps of:
(a) diverting and depressurizing a sour reducing stream effluent from the syngas production zone passing to the shift conversion zone to a blow down conduit associated with the syngas production zone;
(b) passing the effluent from the syngas production zone in step (a) to a low pressure scrubber such as amine or caustic scrubber to remove the H₂S gas;
(c) passing the effluent of the low pressure scrubber to a vent gas combustor having a combustion nozzle and passing the reducing gas through the nozzle and combusting the reducing gas in the combustor under conditions that minimize the creation of nitrogen oxides to create a flue gas;
(d) passing the flue gas from the combustor to a carbon monoxide catalyst zone for the removal of carbon monoxide and a selective catalytic reduction zone to reduce the nitrogen oxides level and then venting the effluent from the catalytic reduction zone to the atmosphere;
(e) diverting and depressurizing the low temperature gas cooling sour reducing zone effluent passing to the acid gas removal zone to a blow down conduit associated with the shift conversion zone, and low temperature gas cooling zone;
(f) passing the effluent from the shift conversion zone in step (e) to a low pressure scrubber such as an amine or caustic scrubber to remove the H₂S;
(g) passing the effluent from the low pressure scrubber to a vent gas combustor having a combustion nozzle and passing the reducing gas through the nozzle and combusting the reducing gas in the combustor under conditions that minimize the creation of nitrogen oxides to create a flue gas;
(h) passing the flue gas from the combustor in step (g) to a carbon monoxide catalyst zone for the removal of carbon monoxide and a selective catalytic reduction zone to reduce the nitrogen oxides level and then venting the effluent from the catalytic reduction zone to the atmosphere; and
(i) diverting and depressurizing the effluent from the acid gas reduction zone as follows:
i. passing a hydrogen rich syngas to vent gas combustor;
ii. passing the acid gas to the sulfur recovery zone;
(j) depressurizing the sulfur recovery zone to tail gas treating unit absorber;
(k) passing the effluent from the tail gas treatment unit absorber to a vent gas combustor having a combustion nozzle and passing the reducing gas through the nozzle and combusting the reducing gas in the combustor under conditions that minimize the creation of nitrogen oxides to create a flue gas;
(l) passing the flue gas from the combustor in step (k) to a carbon monoxide catalyst zone for the removal of carbon monoxide and a selective catalytic reduction zone to reduce the nitrogen oxides level and then venting the effluent from the catalytic reduction zone to the atmosphere; and
(m) switching the fuel to turbines associated with the power block zone from hydrogen to natural gas.

11. The process of claim 10 which process further comprises the steps of:
(a) diverting and depressurizing a sour reducing stream effluent from the temperature gas cooling zone to the blow down conduit associated with this zone;
(b) passing the effluent from the low temperature gas cooling zone to a low pressure scrubber such as amine or caustic scrubber for H₂S removal;
(c) passing the effluent from the low pressure scrubber in step (b) to a vent gas combustor having a combustion nozzle and passing the reducing gas through the nozzle and combusting the reducing gas in the combustor under conditions that minimize the creation of nitrogen oxides to create a flue gas;
(d) passing the flue gas from the combustor to a carbon monoxide catalyst zone for the removal of carbon monoxide and a selective catalytic reduction zone to reduce the nitrogen oxides level and then venting the effluent from the catalytic reduction zone to the atmosphere;
(e) diverting and depressurizing the effluent from the acid gas removal zone as follows:
(i) passing a hydrogen rich syngas to a vent gas combustor;
(ii) passing the acid gas to the sulfur recovery zone;
(f) depressurizing the sulfur recovery zone to a tail gas treating unit absorber;
(g) passing the effluent from the low pressure tail gas treating unit absorber to a vent gas combustor having a combustion nozzle and passing the reducing gas through the nozzle and combusting the reducing gas in the combustor under conditions that minimize the creation of nitrogen oxides to create a flue gas;
(h) passing the flue gas from the combustor in step (g) to a carbon monoxide catalyst zone for the removal of carbon monoxide and a selective catalytic reduction zone to reduce the nitrogen oxides level and then venting the effluent from the catalytic reduction zone to the atmosphere; and
(i) switching the fuel to turbines associated with the power block zone from hydrogen to natural gas.

12. The process of claim 10 which process further comprises the steps of:
(a) diverting and depressurizing the sour reducing stream effluent from the acid gas removal zone as follows;
i) passing a hydrogen rich syngas to the vent gas combustor;
ii) passing the acid gas to the sulfur recovery zone;
(b) depressurizing the sulfur recovery zone to a tail gas treating unit absorber;
(c) passing the effluent from the low pressure tail gas treating unit absorber to a vent gas combustor having a combustion nozzle and passing the reducing gas through the nozzle and combusting the reducing gas in the combustor under conditions that minimize the creation of nitrogen oxides to create a flue gas;
(d) passing the flue gas from the combustor in step (c) to a carbon monoxide catalyst zone for the removal of carbon monoxide and a selective catalytic reduction zone to reduce the nitrogen oxides level and then venting the effluent from the catalytic reduction zone to the atmosphere; and
(e) switching the fuel to the turbines associated with the power block zone from hydrogen to natural gas.

13. The process of claim 7, 8, 9, 10 or 11 wherein the effluent from the vent gas combustor is passed to a heat exchanger or quench column to produce steam thereby cooling the effluent.
